(19) United States
(12) Patent Application Publication
(10) Pub. No.: US 2015/0181151 A1
(43) Pub. Date: Jun. 25, 2015

(54) SYSTEMS AND METHODS FOR MULTIPLE USERS CHANGING CHANNELS ON MULTIPLE DISPLAYS

(71) Applicant: ECHOSTAR TECHNOLOGIES L.L.C., Englewood, CO (US)

(72) Inventors: Phuc H. Nguyen, Parker, CO (US); Christopher William Bruhn, Aurora, CO (US)

(73) Assignee: ECHOSTAR TECHNOLOGIES L.L.C., Englewood, CO (US)

(21) Appl. No.: 14/168,931

(22) Filed: Jan. 30, 2014

Related U.S. Application Data
(60) Provisional application No. 61/918,518, filed on Dec. 19, 2013.

(51) Int. Cl. H04N 5/44; G06F 3/14; H04N 5/445

(52) U.S. Cl. CPC H04N 5/4403; H04N 5/44582; G06F 3/1423; H04N 2005/4442

(57) ABSTRACT

Systems and methods are provided enable multiple users who are in an area containing multiple display devices presenting audiovisual content to easily change the channel on a selected display device by using a conditional access device to arbitrate the channel-changing requests in an organized and fair way.

### CROSS REFERENCE TO RELATED APPLICATIONS

This patent application claims benefit of U.S. Provisional Patent Application No. 61/918,518 filed Dec. 19, 2013, which is hereby incorporated by reference in its entirety.

### BACKGROUND

### Technical Field

The present disclosure generally relates to a single viewer, within a group of viewers in a location, selecting one of several displays presenting audio visual content through internet, satellite, and cable channels, and more particularly to conditional access systems and methods for arbitrating viewer requests to change the channel on the display.

### BRIEF SUMMARY

People frequently find themselves in environments that have a number of different display devices, for example, lounges, gymnasiums, hotel workout rooms, restaurants, sports bars, or common rooms in apartment complexes or university settings, where each device can be tuned to a different program channel. In these environments, users often want to select one of the devices and to change the channel on that selected device to view desired programming content. The multiple display devices may take different forms, for example, several traditional television sets that are hooked up to set top boxes. Another example is a large-screen device connected to a multi-tuner set top box, where the screen is divided into multiple displays, for example, having one channel displayed on the left half of the screen and another channel on the right half of the screen.

In these environments where multiple people have the ability to watch multiple displays, it is important that people are able to easily select a display to watch and listen to the audio portion of the program playing on their selected display. This functionality is disclosed in U.S. patent application Ser. No. 13/910,804, which is incorporated herein by reference in its entirety. Equally important, particularly for the overall viewing enjoyment of the people in the environment, is to have an organized, coordinated way for people to select a display and to change the channel on the selected display with minimal impact on the viewing experience of others.

For example, in a sports bar setting, a customer may walk into the sports bar and see four displays each showing different football games, and the customer may want to view a football game currently in progress but not shown on any of the displays. Typically, the customer has to ask the host or bartender if they could change the channel on one of the displays to the desired game, and the host would then ask people around the bar if it was okay to change the channel on one of the displays. If the host does not think the change would cause undue trouble, the host will change the channel on one of the displays. This process is preferable to giving each person a remote control that allows each person to identify a display device and then immediately change the channel of that device. Chaos would likely ensue as people would have “channel changing fights” and each viewer's enjoyment would be greatly lessened knowing that at any moment the channel the viewer is watching could be changed.

This disclosure is directed to a conditional access device, including related systems and methods that arbitrates or referees viewer requests to change the channel on a selected display in an environment of multiple displays being watched by many people. In one embodiment, the conditional access device serves as a communication link between set top boxes that are directing programming channels to display devices and viewers listening to programming on selected display devices using off-the-shelf headsets or other hardware. This hardware, in addition to being used to listen to audio, allows viewers to send commands like “change the channel” to the conditional access device.

In addition to requests to change channels on displays, other types of changes, for example, adjusting audio levels either in the audiovisual content stream or in the user's listening device and pausing, rewinding and playing the displayed video using set top box functionality, may also be requested and arbitrated by the conditional access device as described herein.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are enlarged and positioned to improve drawing legibility and understanding of the features. Further, the particular shapes of the elements as drawn are not intended to convey any information regarding the actual shape of the particular elements, and have been solely selected for ease of recognition in the drawings.

FIG. 1 is a diagram of one non-limiting embodiment of a system for selecting a display device and changing the channel on the device.

FIG. 2 is a diagram of one non-limiting embodiment of a system for selecting a display within a screen containing several displays based on where a user is looking.

FIG. 3 is a diagram of one non-limiting embodiment of a system for selecting a display from two displays each on a separate device based on where a user is looking.

FIG. 4 is a diagram of several non-limiting embodiments of hardware used by a user to select a display, change the channel on a display, and listen to audio related to video on the display.

FIG. 5 is a block diagram of a non-limiting embodiment of a system for selecting a display from multiple displays and changing the channel on the selected display.

FIG. 6 is a flow diagram showing a non-limiting embodiment of a method that may be performed to enable a user to select a display from multiple displays and to change the channel on the selected display.

FIG. 7 is a flow diagram showing a non-limiting embodiment of a method that may be performed to arbitrate the changing of the channel on a display when multiple users are watching that display.

### DETAILED DESCRIPTION

This application incorporates U.S. patent application Ser. No. 13/910,804 (Attorney Docket Number 290110.580) by reference in its entirety.

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with devices, cameras and systems for tracking eye movements, body movements and gestures have not been shown or described in detail to avoid unnecessarily obscuring descriptions of the embodiments.

Unless the context requires otherwise, throughout the specification and claims that follow, the word “comprise” and variations thereof, such as, “comprises” and “comprising” are to be construed in an open, inclusive sense, that is, as “including, but not limited to.”

References throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment.

The use of ordinals such as first, second and third does not necessarily imply a ranked sense of order, but rather may only distinguish between multiple instances of an act or structure.

The headings and Abstract of the Disclosure provided herein are for convenience only and do not limit the scope or meaning of the embodiments.

In this disclosure, the term “display” includes any device such as a television, computer monitor, video monitor, video projection or portion of a device on which video images of audiovisual content is displayed.

The term “screen” includes any device on which one or more displays can be rendered, such as a picture-in-picture screen on which a smaller display is overlapped on a larger display, or a large flat screen that is tiled into separate displays able to display separate content channels.

The term “channel” includes an audio video service on which a series of programs is presented in sequence.

The term “Smartphone” includes a smartphone device, a tablet device, a mobile computing device, a computer, a speaker system, an entertainment system, a game console, a gaming device, a virtual reality system, and the like.

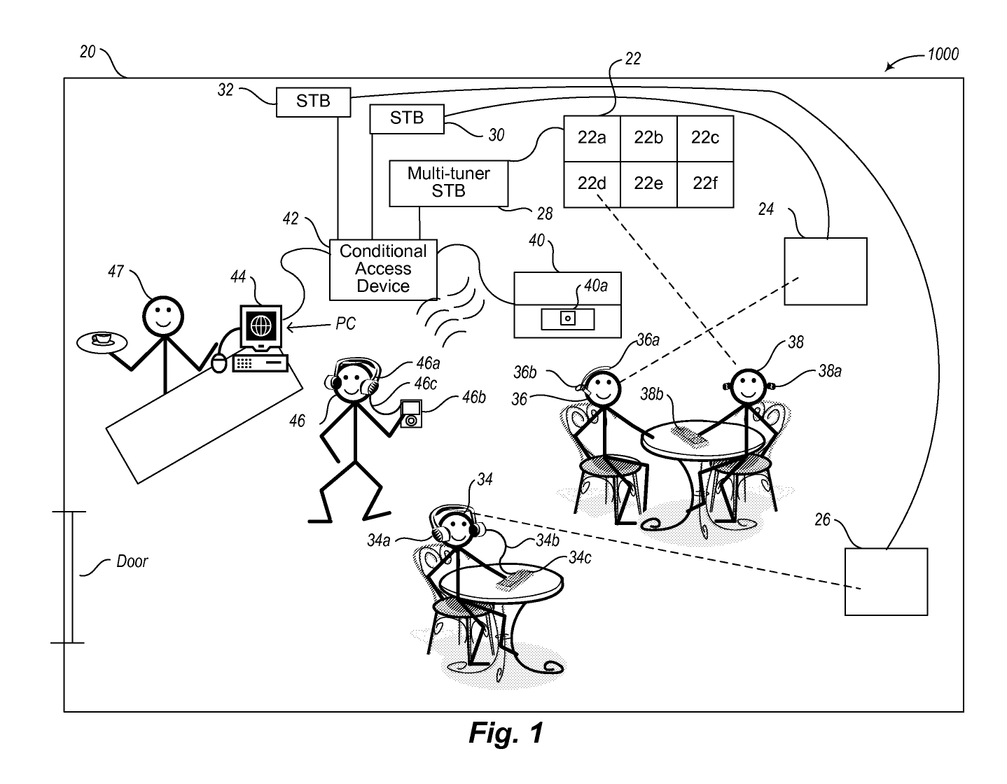

FIG. 1 is a diagram 1000 of a non-limiting example of selecting a display from multiple displays and changing channels on the selected display within a sports bar setting. The sports bar room 20 contains a number of display devices, including screen 22 that contains six tiled displays 22a-22f, and standalone displays 24, 26. Screen 22 is controlled by a multi-tuner set top box 28, which receives multiple programming content, for example, from a head-end device over coaxial cable, and is able to split the content into individual channels and display programs carried on those channels on displays 22a-22f. Display 24 is controlled by set top box 30, and display 26 is controlled by set top box 32. In this sports bar example, each of the separate displays may show a different sports event, for example, different football or basketball games. Individual users 34, 36, and 38 are each watching different displays 26, 24, and 22d, respectively. The display-identification hardware 34a, 36a, and 38a that each individual user 34, 36 and 38 is wearing works in conjunction with receiving device 40 to identify which display each user is looking at, and to provide audio to the user associated with the content shown on the display. The systems and methods that disclose this identification process, including using headphone devices 46a and receiving device 40, are described in U.S. patent application Ser. No. 13/910,804 (Attorney Docket No. 290110.580) filed Jun. 5, 2013, and is incorporated herein by reference in its entirety.

In some situations, users 34, 36 and 38 may be looking at the same display device, and one of the users may wish to change the channel displayed on the device, for example, to watch a different football game. To facilitate this, a conditional access device 42 is used as an arbitrator or referee to determine if and when a user should be able to change the channel or otherwise make any other changes to a display or the content presented on the display. The conditional access device 42 may be implemented in hardware, software, or firmware, and the individual processes and/or components of the device may appear either together or in separate devices or software modules. The conditional access device 42 may also be referred to as an arbitrator or voting processor.

Conditional access device 42 may be connected to several devices in several different ways including by direct connection or wireless connection via Wi-Fi, Bluetooth, infrared, radio frequency, or other wireless communication protocols such as RF4CE/Zibgee. The conditional access device 42, in one or more embodiments, may be connected to a personal computer 44 to register user hardware and to set up channel-changing policies; to set top boxes 28, 30 and 32 to change channels on displays; to receiving device 40 to receive information on which user is currently watching which display; and finally to individual users 34, 36 and 38 to send audio to users and to send and receive commands and information to and from the user. For example, to send voting requests to users and to receive votes from users for changing the channel on a display device. Note: in one embodiment (not shown), the conditional access device 42 may be used in an area having only one display where multiple people want to watch it.

In the sports bar 20 example, a personal computer 44 may be used by a host 47 to configure the conditional access device 42. For example, a user 46 walks into the sports bar carrying a headphone device 46a, which is worn by the user to identify to receiving device 40 the display that the user is currently watching, and may also be used to listen to audio content associated with the video content shown on the display, as disclosed in U.S. patent application Ser. No. 13/910,804. The user may also have a Bluetooth earpiece 38a, which may be connected to the conditional access device 42, to listen to audio. In addition, the user may also have a Smartphone 46b that is connected to conditional access device 42, for example, via Bluetooth, Wi-Fi, or other connection, that can play audio and also send and receive notifications from the conditional access device 42. In addition, the Smartphone 46b may be able to capture user 46 gestures used to send requests to change the channel for a display to the conditional access device 42. A gesture may be captured by using an accelerometer within the Smartphone 46b or by using a video camera within Smartphone 46b to capture phone movement or a user's 46 head or hand movements that communicate a request to be sent to conditional access device 42. The headphone device 46a may also contain an accelerometer to capture head movement gestures that correspond to requests. The headphones may also contain buttons or switches that a user would press to send a request.

In the above example, the personal computer 44, the conditional access device 42, set top boxes 32, 30, multi-tuner set top box 28 and receiving device 40 have been described as separate devices. In some embodiments however, one or more of the functions of these devices may be combined into a single unit or multiple units.

After user 46 has registered with host 47, the user will take a place somewhere within the sports bar 20 and begin to watch the video content on one of the displays 22a-f, 24, 26. For example, user 34 is seated at a table watching display 26. The receiving device 40, which is in communication with the headphone 34a, knows that user 34 is watching display 26 and sends that information to the conditional access device 42. During the example registration process for user 34, the conditional access device 42 registered Smartphone 34c as the audio receiver and will play received sound to user 34 through Smartphone headphones 34b. For user 36, during the registration process the conditional access device 42 registered Bluetooth earpiece 36b and will play audio corresponding to the display 24 that the user is looking at, determined by receiving device 40. During the registration process for user 38, the system registered Smartphone 38b as the audio receiving device which is paired with Bluetooth earpiece 38a so user 38 can hear programming audio while watching screen 22d. In an alternate embodiment, the audio associated with display 22d could be played to user 38 over the speaker of Smartphone 38b.

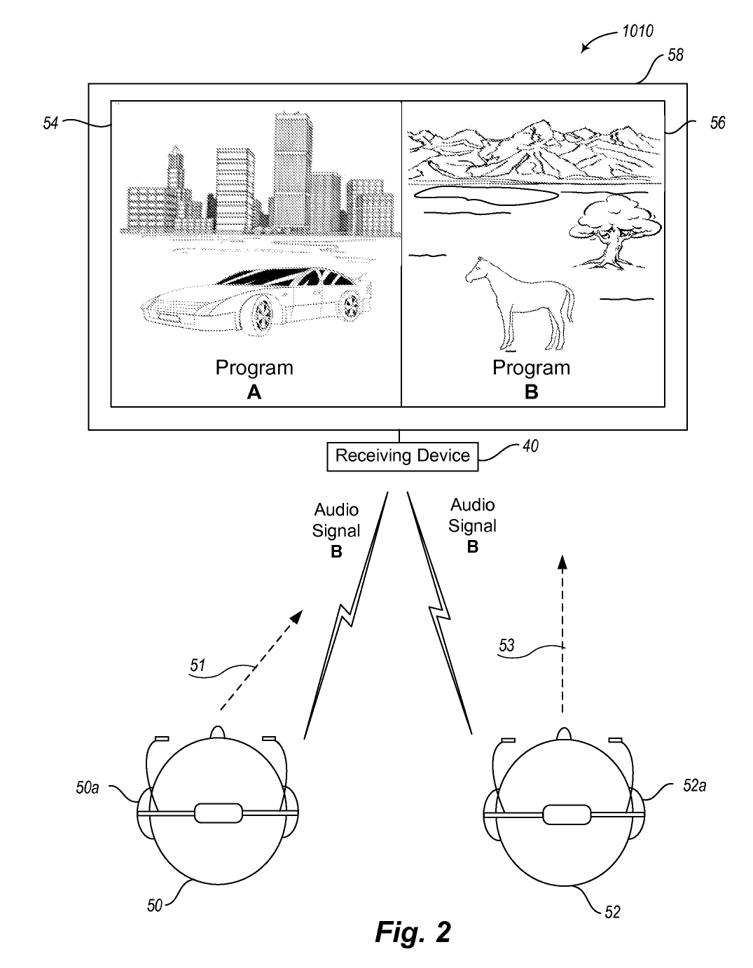

FIG. 2 is a diagram 1010 of one non-limiting illustrated embodiment of U.S. patent application Ser. No. 13/910,804 that shows how headphone devices 50a, 52a are able to determine which displays their respective users 50 and 52 are looking at. On screen 58, there are two different displays of programs, Program A 54 and Program B 56. In this embodiment, receiving device 40 is able to send audio for either program to either user's headphone devices 50a, 52a. In this example, user 50 is looking in direction 51 at program B on display 56, and thus receives the audio signal for Program B. The other user 52 is looking in direction 53, also on display 56 showing Program B, and thus receives the audio signal for that program as well.

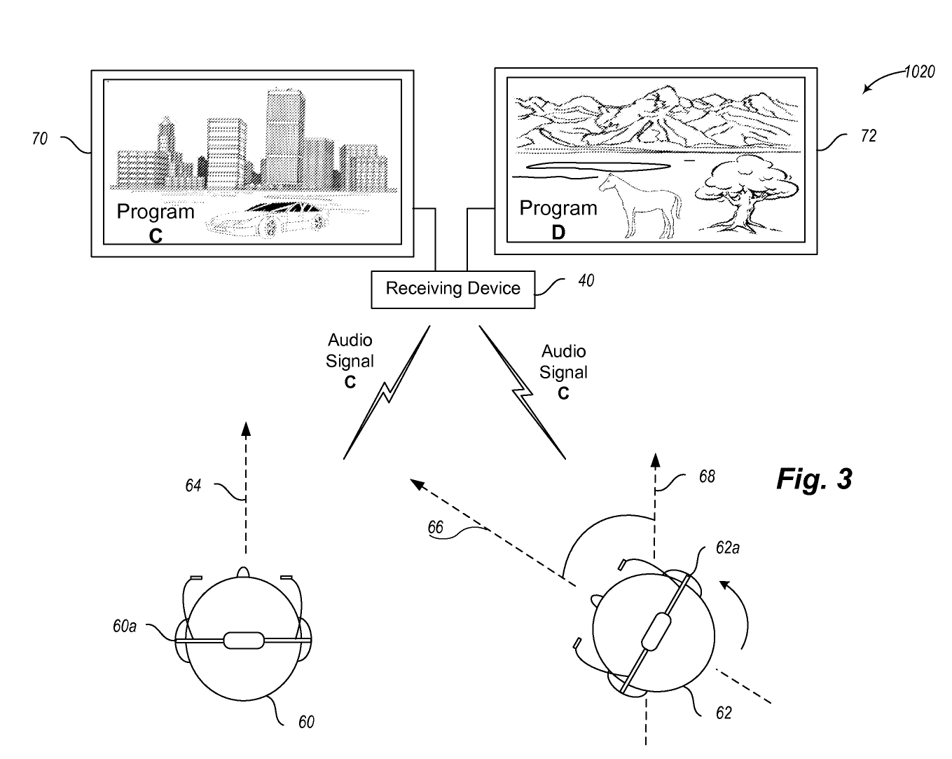

FIG. 3 is a diagram 1020 of one non-limiting illustrated embodiment of U.S. patent application Ser. No. 13/910,804 that shows how headphone devices 60a, 62a are able to determine which displays respective users 60 and 62 are looking at. Displays 70, 72 are on different devices and displaying different Programs C and D respectively. Receiving device 40 is connected to displays 70 and 72, determines which display the user is watching, and sends the audio corresponding to the program being played on the watched device. In this example user 60 is looking in direction 64 at display 70, and is receiving audio for program C on the earphones of headset 60a. User 62 is looking in direction 66 at display 70 (as detected by movement of the user's head from the direction 68), and thus user 62 receives audio signal for the program C on the earphones of headset 62a being displayed on display 70. In both FIGS. 2 and 3, an alternate embodiment would be for receiving device 40 to contain a camera (not shown) that would identify each user 50, 52 and at which display the user was watching.

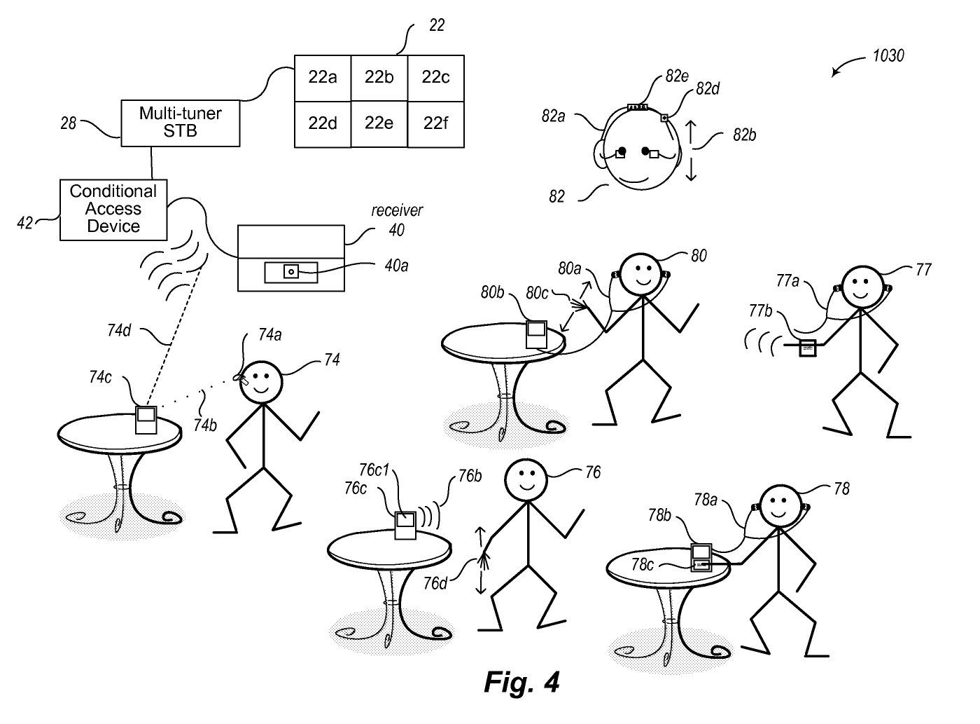

FIG. 4 is diagram 1030, which shows a number of non-limiting illustrated embodiments of devices used to change channels and how users may interact with those devices. In each of the examples of users in FIG. 4 with the exception of user 80, the headphones described in FIGS. 2 and 3 used to determine what display a user is looking at have been omitted.

Different users 74, 76, 78, 80, and 82 are interacting with non-limiting examples of different combinations of hardware devices that allow the user to receive audio from a display and also interact with the display through the conditional access device 42. User 74 is an example of a user with a registered Smartphone 74c connected to the user's Bluetooth earpiece 74a over Bluetooth link 74b. Smartphone 74c is connected wirelessly 74d either via Bluetooth or Wi-Fi to the conditional access device 42. In this example, audio corresponding to the display that user 74 is watching is sent via the conditional access device 42 to Smartphone 74c, then to earpiece 74a.

User 76 is an example of a registered Smartphone 76c connected to the conditional access device 42 in a wireless connection. Audio corresponding to the content presented on a display on-screen 22 is played on the Smartphone speakers 76b so that user 76 can hear. If user 76 wishes to communicate to the conditional access device 42, for example, to change the channel of the device being watched, user 76 could use gestures, for example, hand motions 76d that are picked up by the Smartphone's camera 76c1, which are converted by a Smartphone application to a channel change request, and sent via wireless communication to the conditional access device 42. In this example, if the system was able to successfully change the channel, conditional access device 42 would send a message to Smartphone 76c letting user 76 know that the channel was successfully changed. If the system was not able to successfully change the channel, then the conditional access device 42 would notify Smartphone 76c that the channel cannot be changed. The user 76 could then be notified, for example, of different displays within the area that are showing the user's desired channel by giving a display identification number or by pointing to the display with an arrow on the Smartphone 76c screen where user 76 should look.

User 77 is an example of a registered smart watch 77b that is connected to the conditional access device 42 in a wireless connection. In one embodiment, smart watch 77b receives audio corresponding to the screen 22 that user 77 is watching, and sends that audio to user 77 through earbuds 77a. In addition, in one or more embodiments, user 77 may be able to send requests to change channel, change sound volume, query who else is watching the screen, or other requests through the smart watch 77b, for example, by moving the watch or by entering commands through the smart watch 77b interface.

User 78 is an example of a Smartphone 78b that is wirelessly connected to conditional access device 42 and provides audio of a watched display user 78. In this example though, user 78 communicates with conditional access device 42 using an application 78c on the Smartphone 78b. Request to change channel, change sound volume, or other requests can be entered through application 78c, and responses from conditional access device 42 may be received by application 78c and displayed to user 78.

User 80 is an example similar to user 76, except that earbuds 80a connecting Smartphone 80b to user 80 are used, rather than relying on the speakers in Smartphone 80b. Communications to change the channel of the watched display are made via gestures 80c, which in this example are read and interpreted by camera 40a in receiving device 40 to determine the desired channel user 80 wishes to change the watched display to. This desired channel is communicated to conditional access device 42. If the channel is able to be successfully changed a notice that the channel has been changed is sent to Smartphone 80b. Otherwise, user 80 is notified of different displays within the area that are showing the channel the user would like to view, and where to turn to see those displays.

The hardware worn by user 82 shows an example headset 82a that is used by receiving device 40 to identify which display within screen 22 user 82 is looking at. As a result, either the receiving device 40 or conditional access device 42 sends audio corresponding to the program on the watched display back to headphone 82a. User 82 may send signals to conditional access device 42, for example, to change channels, by reaching up and clicking button 82d, which, for example, may request that the channel associated with the watched device is incremented or decremented. In addition, accelerometer 82e may be used to interpret head nods 82b or head shakes that signal the system to change the channel on the watched display.

Each of these examples illustrate how registered hardware from a user may be used to interact with the system. These examples are non-limiting example embodiments.

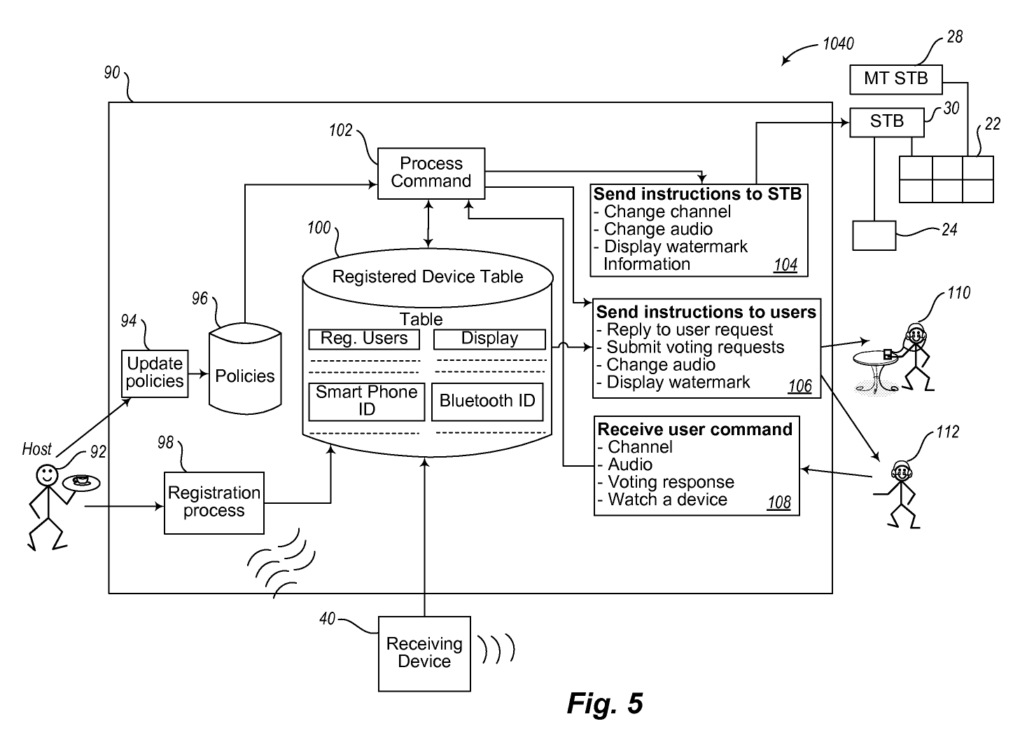

FIG. 5 shows diagram 1040 which is a non-limiting embodiment of a system 90 that implements a conditional access device 42. Inputs to the system 90 include inputs to register hardware that a user 110, 112 uses to select a display to watch, to change the channel on the selected display, to listen to audio, and to communicate with the system. These hardware registration inputs may be entered by host 92 by inspecting the user's hardware and entering information into personal computer 44 that is connected to registration process 98 that registers the user and hardware. This hardware may include a headset, as described in U.S. patent Ser. No. 13/910,804, an off-the-shelf headset, a Bluetooth earpiece receiver, or a Smartphone configured to send and receive information between the user and the system 90, or configured to receive audio that corresponds to the displayed channel and to play that audio to the user. Other hardware may also be registered and used. After hardware registration, the information is stored in a registered device table 100, which is a database that includes information for each registered user, for example, the display the user is currently watching, and an identification number such as a MAC address for user devices such as the headset, Smartphone, or Bluetooth device used by the user. This registration may be done electronically by identifying previously registered users and hardware and reactivating the hardware when it is within range of system 90.

The host 92 may also use personal computer 44 to update policy information 94, which is stored in a policy database 96. The policy database includes information that identifies displays controlled under system 90 and how these displays may be interacted with. Policy database 96 also contains individual user parameters, preferences, and limitations concerning a user's interaction with system 90, for example, if the user is temporarily blocked from attempting to change a channel because of too many attempts to change the channel within a certain period of time. Policy information may also identify initial assignments of channels to display devices and identify channels that can never be changed by users, for example, having a 24 hour cable news channel always displayed on a dedicated news display.

When a user 112 sends a command to system 90, for example, to change the channel, to adjust audio volume, or respond to a vote to change the channel, this request is received by the “Receive User Command” module 108. The received user commands are then passed to the “Process Command” module 102 that determines if the user command is allowable given the policies from database 96 and the information in the registered device table 100. If the command is allowable, then appropriate instructions are sent out via the “send instructions to STB” module 104 to a multi-tuner set top box 28 or a traditional set top box 30. Examples of these commands range from changing the channel on a display to placing a watermark image over a display to show how many people are watching the display. Instructions may also be sent to the “send instructions to users” module 106. This module will communicate directly with users, for example, to reply to a user's request to change the channel on the display or to indicate to a user which display to look at to view the channel the user wishes to view.

The system 90 also interacts with the receiving device 40 that identifies the display devices that each user is looking at. The receiving device is further described in U.S. patent application Ser. No. 13/910,804. The information received from receiving device 40, for example, includes the identifier of each display device and identification of the user that is watching each display device. This information is stored and regularly updated in the registered device table 100.

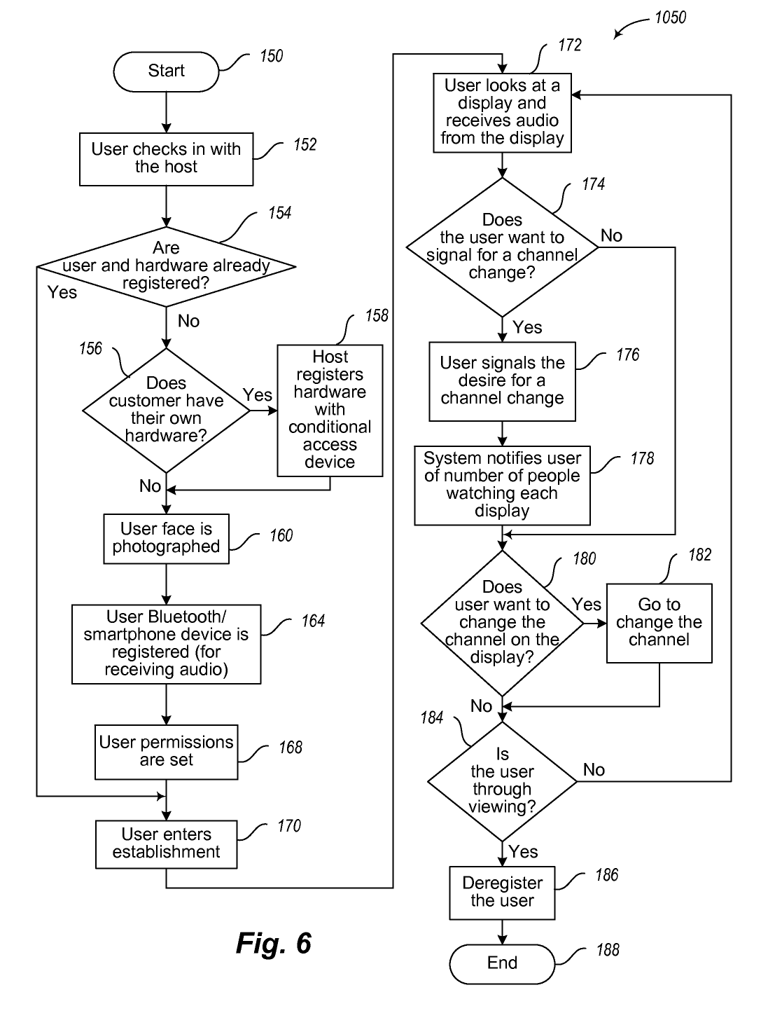

FIG. 6 is a flow diagram 1050 describing one non-limiting embodiment of a portion of a method for implementing a conditional access device 42 at a sports bar, in particular registering the user and the user's devices with the system and managing the user's display-viewing experience. At 150, the process starts. At step 152, the user checks in with the host 47 at the sports bar to register the user's equipment, such as headset, Bluetooth earpiece, or Smartphone with the conditional access device 42. This registration enables the user to select one of several displays to view, to listen to programming on the selected display, and to attempt to change the channel on the selected display. At step 154, if the user and the hardware are already registered, then the process moves to step 170. Otherwise, at step 156 if the user has their own hardware, then at step 158 the host registers the user's hardware with the conditional access device 42. In another embodiment, the host may provide the user with all the necessary hardware to view the different display devices within the sports bar. At step 160, the user's face is photographed and used by the receiving device 40 to identify where each user is and which device the user is looking at, which is explained more fully in U.S. patent application Ser. No. 13/910,804. At step 164 the user's devices are registered with the conditional access device 42, which will enable the user to receive audio through the user's hardware and also to send commands and receive messages from the conditional access device. At step 168, user permissions are set with the system. This step may be done with the assistance of the host, who enters in specific permissions based on characteristics of the user, for example, if the user is a regular patron of the sports bar, or if the user belongs to a special group like a sports team fan club or fantasy sports league member. In other embodiments, such as a family restaurant, headsets and other hardware given to children may have the ability to change the channel turned off because children may not understand how this works and may disrupt the normal flow of viewing within the restaurant.

At step 170, the user enters the establishment, here the sports bar. At step 172, the user, once inside the sports bar, looks around at different displays to select the display the user wants to watch. By looking at a particular display, the user is able to select it for watching as disclosed in U.S. patent application Ser. No. 13/910,804. At step 174, if the user would like to watch a channel, without specifically requesting that the channel on the selected display be changed, the user can request that the system show what channels are playing on which displays by signaling for a channel change step 176. This request may take the form of a gesture such as a head nod or movement that is detected by, for example, an accelerometer in the user's headset or picked up visually through a camera either in the receiving device 40a or the user's Smartphone that is registered with the conditional access device 42, selecting a button in the users headset, or communicating with the conditional access device 42 via the user's Smartphone. When the system receives this request, then at step 178 the system will notify the user of what channels are currently playing on which displays within the sports bar. The system may do this in a number of ways. One example is to show a watermark image on each display showing the channel being displayed and the number of users in the room currently viewing the display. In another example, the system sends the viewing information to the user's Smartphone where the user can view the display devices and the channels being shown on them. In another example, the system provides audio feedback to the user through the user's headphones describing what channel is playing on which display device. The identification of the display device can be accomplished by giving a specific device identifier, such as “display 1” or “the upper left display on the main screen.” In addition, the system may identify the display relative to the location of the user, for example, “the display to your left” or “the display directly behind you.” In an alternative embodiment, the user may inform the system, through button presses, gestures, or via the user's Smartphone, that the user wants to watch a specific channel. In response to this request, the system may inform the user of the locations of one or more displays where the channel is being shown, and if the channel is not being shown, direct the user to a display that is not being watched so that the user can change the channel of that display to the desired channel.

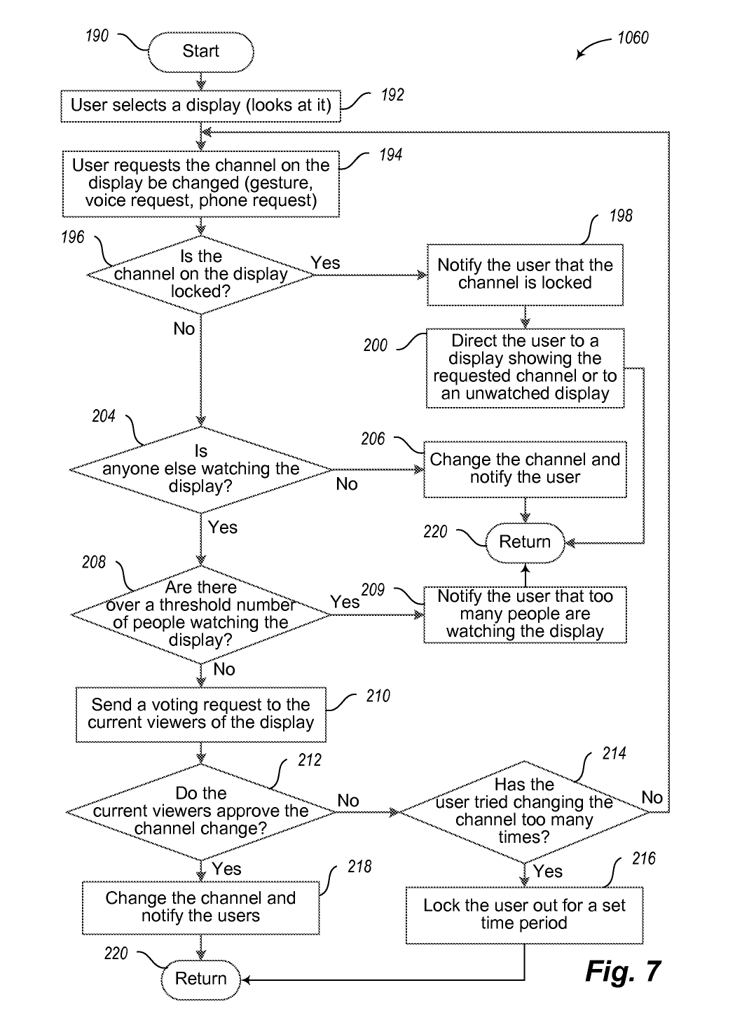

At step 180, if the user wants to change the channel on a selected display, the process will go through a series of steps involving voting to change the channel 182 described in diagram 1060 in FIG. 7. Otherwise, the user will continue to watch the channel on the display until the user selects a different display. At step 184, if the user is through watching displays, then at step 186 the user deregisters the device by either's pushing a button or making a gesture and returns hardware to the host and the process ends 188. Alternatively, if the registered hardware belongs to the user, in some embodiments the user would just leave the establishment, which would cause the user and hardware to be deregistered from the system.

FIG. 7 is a flow diagram 1060 describing one non-limiting embodiment of a portion of a process for implementing a user request to change the channel on a display device using conditional access device 42. At 190, the process starts. At 192, the user selects a display to view as disclosed in U.S. patent application Ser. No. 13/910,804. At step 194, the user requests that the channel on the selected display be changed. This may be done in a number of different ways including through selecting a button on the user's headset device, making a gesture that is recorded by an accelerometer or by a video camera, or by inputting the request into the user's Smartphone device. In other embodiments, the user may speak the request into a microphone where a voice recognition application determines the request to change the channel. At step 196, if the channel on the display is not locked, then the process flow proceeds to step 204. A display device may be locked, for example, if the host at the sports bar knows that many patrons would like to watch a particular game, the host may set the channel on several displays to the channel showing the game and lock the channel on those displays from being changed. If the channel on the display is locked, then at step 198 the user is notified, for example, by an audio message sent to the user's headphones or a text message sent to the user's Smartphone. Then at step 200, the system will direct the user to another display showing the requested channel, or to an unwatched display on which the user can change the channel. The user may be directed by the system to the display by using audio, for example, “the channel you are requesting is being shown on the display to your left,” “your channel is on display 5,” or “the channel you requested is now being shown on display 2.” In some embodiments, the audio will continue to direct the user to the correct display until the user looks at it. In other embodiments, directions to view the correct display may be sent to the user's Smartphone as text directions, or as an arrow on the Smartphone's screen pointing to the display where the user should look.

At step 204 the system determines whether anyone else is watching the display. If there is no one else watching the display, then at step 206 the channel on the display is changed, the user is notified; and the process returns to step 220. Otherwise, if there are other people watching the display then at step 208 the system checks to see if there are a threshold number of users that are watching the display. There may be a large number of users in the room, over a threshold number, who are watching a particular display because it is showing the end of a close football game, or a popular television series. When the number of viewers exceeds a threshold for a display, the system treats that display as locked so that the large number of viewers are not disturbed by an individual user requesting to change the channel. If there are a threshold number of users watching a display, then the channel is not changed and the process goes to step 209 where the user is notified that too many people are watching the display for the display to be changed, and the user is returned to step 220.

Otherwise, if there are fewer than a threshold number of users watching a particular display, then at step 210 a democratic process of voting for the channel change among all users watching the display is initiated. In one embodiment, each of the users viewing the display are notified that one of the viewers wishes to change the channel on the display. This notification may take the form of a watermark message appearing on the display, an audio notification sent to each user, or a message sent to each user's Smartphone, informing them of the channel change request and asking them to vote on whether they approve or disapprove of the change. Users may vote in a number of ways, including through gestures, through button presses on headphone sets, through speaking into a microphone or through responding over their Smartphones. At step 212, if the users viewing the display approve, then at step 218 the channel is changed and the users are notified and at step 220 the process returns. If users viewing a display do not approve of the channel change, then the channel is not changed. At this point, the system may check if the user requesting the channel change is inappropriately repeating the request. At step 214 the system determines whether the user has tried changing the channel too many times. For example, the system may have a threshold value for the number of unsuccessful consecutive attempts to change the channel allowed by a user within a given period or a threshold value for how many requests could be allowed for a given time period. At step 216, if the user has exceeded this channel changing threshold the system will lock the user out and prevent the user from changing channels for a set time period. At step 220, the process returns.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer-implemented method comprising:
receiving configuration information requesting to register hardware used by a user to receive audio and control video displayed on one or more displays;
receiving an identification of a selected display by the user using the registered hardware;
receiving a command from the user to change the channel presented on a selected display viewed by the user;
determining whether the received command is allowed; and
if the command is allowed, sending, using the received configuration information, a request to change the channel on the selected display.

2. The computer-implemented method of claim 1 wherein the selected display is one of a single video display or one display of a multiple picture-in-picture display.

3. The computer-implemented method of claim 1 wherein receiving a command from the user uses one of:
RF4CE/Zigbee;
Bluetooth™; or
WiFi.

4. The computer-implemented method of claim 1 further comprising:
wherein the element of receiving a command to change the channel further comprises receiving a command to adjust the volume of the audio of the channel displayed to the user; and
wherein the element of sending a request to change the channel on the selected display further comprises sending a request to adjust the volume of the audio of the channel displayed to the user.

5. The computer-implemented method of claim 1 wherein the element of determining whether the received command is allowed further comprises:
receiving from a third party policy information used to identify conditions under which the received command is allowed; and
determining, by analyzing the policy information, whether the command is allowed.

6. The computer-implemented method of claim 1 wherein the policy information includes one or more of:
maximum number of viewers;
a program identifier;
a timeslot identifier; or
a channel identifier.

7. The computer-implemented method of claim 1 wherein the element of determining whether the received command is allowed further comprises:
determining whether the channel on the display of the selected display is currently being watched by another user;
if the selected display is being watched by another user then
sending a vote request to the users with received configuration information that are currently watching the selected display;
receiving the vote responses from the users with received configuration information that are currently watching the selected display; and
determining, by analyzing the vote responses, whether the command is allowed.

8. A system comprising:
a computer processor;
a non-transitory memory coupled to the processor;
a module running on the non-transitory memory configured to:
receive configuration information requesting to register hardware used by a user to receive audio and control video displayed on one or more displays;
receive an identification of a selected display by the user using the registered hardware;
receive a command from the user to change the channel presented on a selected display viewed by the user;
determine whether the received command is allowed; and
if the command is allowed, send, using the received configuration information, a request to change the channel on the selected display.
